(19) United States
(12) Patent Application Publication
(10) Pub. No.: US 2014/0087332 A1
(43) Pub. Date: Mar. 27, 2014

(54) MULTILAYER MOUTHPIECE, MANUFACTURING METHOD AND MANUFACTURING DEVICE THEREOF

(71) Applicants: Tomokazu Ueda, Hikone-shi (JP); Junko Ueda, Hikone-shi (JP)

(72) Inventors: Tomokazu Ueda, Hikone-shi (JP); Junko Ueda, Hikone-shi (JP)

(21) Appl. No.: 14/116,613

(22) PCT Filed: May 9, 2012
(86) PCT No.: PCT/JP2012/061884

§ 371 Date: Nov. 8, 2013

(30) Foreign Application Priority Data
May 9, 2011 (JP) 2011-104765

(51) Int. Cl. A61C 13/01; A61C 19/06; B29C 43/20; A61C 5/14

(52) U.S. Cl. CPC A61C 13/04; A61C 5/14; A61C 19/063; B29C 43/203
USPC 433/199.1; 128/862; 428/174; 264/16; 425/2

(57) ABSTRACT

The present invention has aimed to provide a multilayer mouthpiece for rubbing teeth and gums to supply stimulation thereto.

The multilayer mouthpiece includes: a tray of thermoplastic resin for covering teeth; and a rub stimulation sheet which is on the tray of the thermoplastic resin for supply rub stimulation to the gums and teeth.

### TECHNICAL FIELD

The present invention relates to: a multilayer mouthpiece; and a manufacturing method for the multilayer mouthpiece; and a manufacturing device for the multilayer mouthpiece. Specifically, the present invention relates to: a multilayer mouthpiece suitable for treatment and prevention of infection of an oral cavity of a healthy person, a person requiring long-term care, and a physically challenged person against a virus and a bacterium, and suitable for rehabilitation of a person requiring long-term care; and a manufacturing method for this multilayer mouthpiece; and a manufacturing device of this multilayer mouthpiece.

### BACKGROUND ART

Known is a mouthpiece (device for promoting secretion of saliva) that includes an occlusion part and a grip part. The occlusion part is a bar-like member made by molding an elastic resin, and has upper and lower sides that are a straight line, convex, or concave in a cross section view. At least one of the upper and lower sides of the bar-like member is to be in contact with an edentulous jaw ridge corresponding to a molar tooth covered with a gum. The grip part is connected to the occlusion part. The mouthpiece is characterized in that a distance between center points of the upper and lower sides of the bar-like member is approximately equal to a distance between tops of upper and lower alveolar ridges at the center of occlusion in a dentulous condition, or about a half of the distance between the tops of the alveolar ridges (see, Patent Literature 1).

### CITATION LIST

### Patent literature

Patent Literature 1: JP 2010-194196 A

### SUMMARY OF INVENTION

### Technical Problem

However, a conventional mouthpiece still have a problem that some of users cannot chew the mouthpiece with entire upper and lower rows of teeth including front and back teeth and consequently the mouthpiece cannot supply stimulation uniformly to the teeth (or the teeth and/or the gums).

The objective of the present invention is to provide a mouthpiece capable of rubbing gums for teeth and gums) to supply stimulation uniformly to the gums (or the teeth and gums).

Note that, in the present invention, the term “uniformly” is not used to refer to uniformity in such a strict sense that the same force is applied to every part but is used to refer to more uniformly than the invention described in Patent Literature 1.

Therefore, the expression “capable of rubbing the gums (or the teeth and gums) to supply uniform stimulation thereto” means capable of rubbing the whole gums (or the whole teeth and gums) to supply stimulation thereto.

### Solution to Problem

The multilayer mouthpiece in accordance with the present invention is characterized by including: a tray of thermoplastic resin for covering teeth; and a rub stimulation sheet for rubbing gums to supply stimulation to the gums, the rub stimulation sheet being on the tray of the thermoplastic resin.

The manufacturing method for the multilayer mouthpiece in accordance with the present invention is characterized in that the manufacturing method is a manufacturing method tor the above mentioned multilayer mouthpiece and includes: a step of preparing a plaster cast by impression taking; and a heating and pressure molding step of performing heat and pressure molding while covering the plaster cast with the rub stimulation sheet and a sheet of the thermoplastic resin in such a manner that the rub stimulation sheet is in contact with the plaster cast.

The manufacturing device 51 in accordance with the present invention is characterized in that the manufacturing device 51 is a manufacturing device for the aforementioned multilayer mouthpiece and includes: a heater for heating a face, to be heated, of the sheet of the thermoplastic resin to a softening temperature; and a holding arm configured to hold the sheet of the thermoplastic resin and to reverse the face of the sheet of the thermoplastic resin: and a table for fixing a plaster cast, wherein: the heater, the holding arm, and the table are arranged in this order from the face of the sheet of the thermoplastic resin along a vertical direction, to the face of the sheet of the thermoplastic resin; and the holding arm and the table are configured to approach each other.

The manufacturing device 52 in accordance with the present invention is characterized in that the manufacturing device 52 is a manufacturing device for the aforementioned multilayer mouthpiece and includes: a heater for heating a face, to be heated, of the sheet of the thermoplastic resin to a softening temperature: a holding arm is configured to move on a virtual plane parallel to the face with holding the sheet of the thermoplastic resin; and a table for fixing a piaster cast, wherein: the holding arm is further configured to move between a position in the virtual plane facing the heater and a position in the virtual plane facing the table; and the holding arm and the table are configured to approach each other while the holding arm is in the position in the virtual plane facing the table.

### Advantageous Effects of Invention

The multilayer mouthpiece in accordance with the present invention can cover teeth with a tray of thermoplastic resin, and therefore it is possible to chew the multilayer mouthpiece with the entire upper and lower rows of teeth. Besides, the multilayer mouthpiece in accordance with the present invention includes the rub stimulation sheet on a tooth side (inside) of the multilayer mouthpiece. Hence, with using the multilayer mouthpiece in accordance with the present invention, it is possible to rub the gums (or the teeth and gum is) to supply stimulation uniformly thereto.

The manufacturing method for the multilayer mouthpiece in accordance with the present invention is suitable for manufacture of the multilayer mouthpiece described above, and can facilitate manufacture of the multilayer mouthpiece described above.

The manufacturing devices 51 and 52 in accordance with the present invention are suitable for manufacture of the multilayer mouthpiece described above, and can facilitate manufacture of the multilayer mouthpiece described above.

### BRIEF DESCRIPTION OF DRAWINGS

FIG. 1 is a photograph showing an embodiment of a multilayer mouthpiece according to the present invention (the multilayer mouthpiece including a prosthetic tooth disposed on a tray of thermoplastic resin correspondingly to a space of a lost tooth on an upper jaw), which is worn on a plaster cast;

FIG. 2 is a photograph showing the upper jaw (with the space of the lost tooth) corresponding to the multilayer mouthpiece shown in FIG. 1;

FIG. 3 is a photograph showing an embodiment of the multilayer mouthpiece according to the present invention (the multilayer mouthpiece including prosthetic teeth disposed on a tray of thermoplastic resin correspondingly to spaces of lost teeth on a lower jaw), which is worn on a plaster cast;

FIG. 4 is a photograph showing the lower jaw (with the spaces of the lost teeth) corresponding to the multilayer mouthpiece shown in FIG. 3;

FIG. 5 is a photograph that shows labial surfaces of upper and lower jaw teeth (Patient “A”) and is taken before the multilayer mouthpiece 21 obtained in Example 1 is worn thereon;

FIG. 6 is a photograph, that shows the labial surfaces of the upper and lower jaw teeth (Patient “A”) and is taken after about 2 months wearing the multilayer mouthpiece 21 obtained in Example 1;

FIG. 7 is a photograph that shows the tooth No. 36 (of Patient “A”) and the surrounding area and is taken before wearing the multilayer mouthpiece 21 obtained in Example 1;

FIG. 8 is a photograph that shows the tooth No. 36 (of Patient “A”) and the surrounding area and is taken after about 2 months wearing the multilayer mouthpiece 21 obtained in Example 1;

FIG. 9 is a photograph that shows labial surfaces of upper and lower jaw teeth (Patient “B”) and is taken before the multilayer mouthpiece 22 obtained in Example 2 is worn thereon;

FIG. 10 is a photograph that shows the labial surfaces of the upper and lower jaw teeth (of Patient “B”) and is taken after about 3 months wearing the multilayer mouthpiece 22 obtained in Example 2;

FIG. 11 is a cross-sectional view schematically illustrating a step of preparing a plaster cast by trimming a gum portion of a model formed by impression taking in such a manner to more expose teeth of the plaster cast, in the step of preparing the piaster cast by impression taking (trimmed parts are illustrated with wavy lines);

FIG. 12 is a perspective view schematically illustrating a step of preparing a sheet of thermoplastic resin having protrusions by placing a sheet of thermoplastic resin on a mold having dimples formed thereon and subsequently molding the sheet by heating;

FIG. 13 is a perspective view schematically illustrating a sheet of thermoplastic resin with protrusions;

FIG. 14 is a cross-sectional view schematically illustrating a structure in which through-holes are formed in a rub stimulation sheet and a sheet of thermoplastic resin which have been molded by heating and pressing;

FIG. 15 is a cross-sectional view schematically illustrating a step, subsequent to the step of making through-holes in the rub stimulation sheet and the sheet of the thermoplastic resin which have been molded by heating and pressing, of placing another sheet of the thermoplastic resin on the sheet of the thermoplastic resin with the through-holes; and molding the sheets by heating to form protrusions on the tooth side of the tray of the thermoplastic resin, the protrusions penetrating the rub stimulation sheet so that the protrusions can nib the gums and/or the teeth directly to supply stimulation thereto;

FIG. 16 is a conceptual diagram schematically illustrating relative positions and movements (arrows indicate directions of the movements) of a heater, a holding arm, and a table in a manufacturing device 51 in accordance with the present invention;

FIG. 17 is a conceptual diagram schematically illustrating relative positions and movements (arrows indicate directions of the movements) of a heater, a holding arm, and a table in a manufacturing device 52 in accordance with the present invention;

FIG. 18 is a conceptual diagram schematically illustrating relative positions and movements (arrows indicate directions of the movements) of a heater, a holding arm, and a table in a manufacturing device (H1) which is commercially available;

FIG. 19 is a conceptual diagram schematically illustrating relative positions and movements (arrows indicate directions of the movements) of a heater, a holding arm, and a table in a manufacturing device (H2) which is commercially available;

FIG. 20 is a schematic perspective view of a multilayer mouthpiece in accordance with the present invention prepared with a plaster cast having an average size;

FIG. 21(a) is a cross-sectional view schematically showing a state where a multilayer mouthpiece in accordance with the present invention is worn on teeth and gums;

FIG. 21(b) is a cross-sectional view schematically showing a condition where part of the rub stimulation sheet in contact with a top of teeth and the like and the tray of the thermoplastic resin in the vicinity of this part are compressed by making the upper and lower teeth occlude with each other through chewing (tapping) in the above state;

FIG. 22 is a perspective view of a multilayer mouthpiece in accordance with the present invention that includes the prosthetic tooth on the tray of the thermoplastic resin correspondingly to a space of a lost tooth.

FIG. 23 is a schematic cross-sectional view which is taken along with the line A-A′ of FIG. 22 and illustrates an example of the multilayer mouthpiece having protrusions on the tooth side of the tray of the thermoplastic resin, with the rub stimulation sheet being disposed in such a manner to cover the protrusions, which are to be in contact with gums, and being not disposed on a portion to be in contact with the top of the teeth;

FIG. 24 is a schematic cross-sectional view which is taken along with the line A-A′ of FIG. 22 and illustrates an example of the a multilayer mouthpiece having protrusions on the tooth side of the tray of the thermoplastic resin, the tips of the protrusions being exposed from the rub stimulation sheet;

FIG. 25 is a partial side view which relates to the multilayer mouthpiece shown in FIG. 22 and schematically illustrates the prosthetic tooth and the vicinity thereof viewed in a B-arrow direction; and

FIG. 26 is a perspective view of a multilayer mouthpiece in accordance with the present invention in which the rub stimulation sheet and the tray of the thermoplastic resin each are devoid of a portion to be in contact with the top of the tooth and prosthetic teeth are disposed correspondingly to spaces of lost teeth.

### DESCRIPTION OF EMBODIMENTS

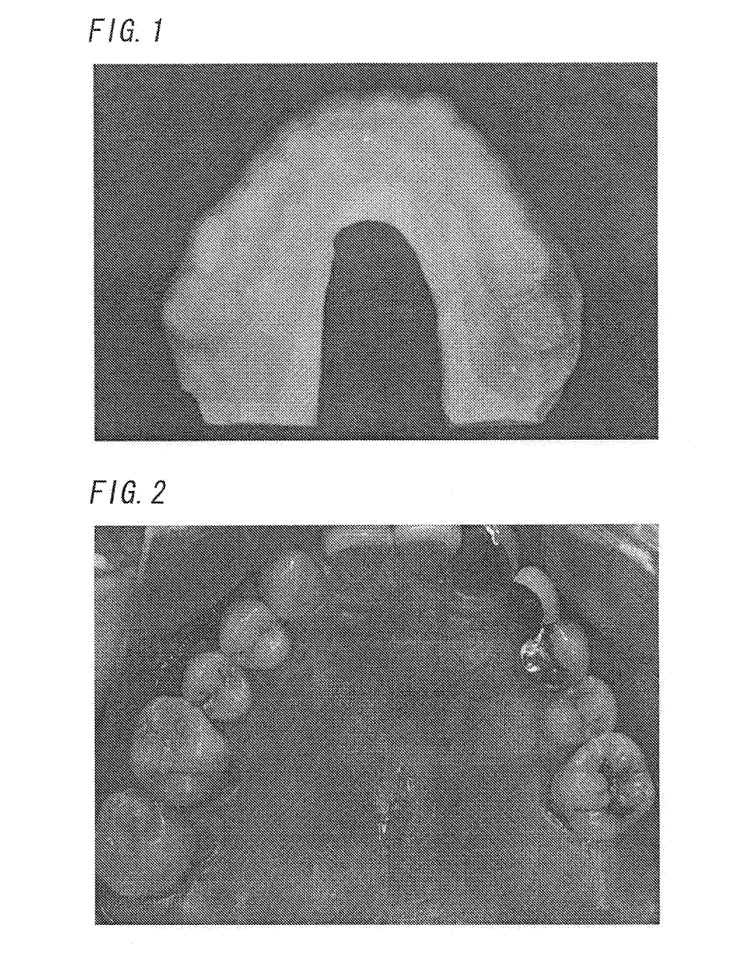

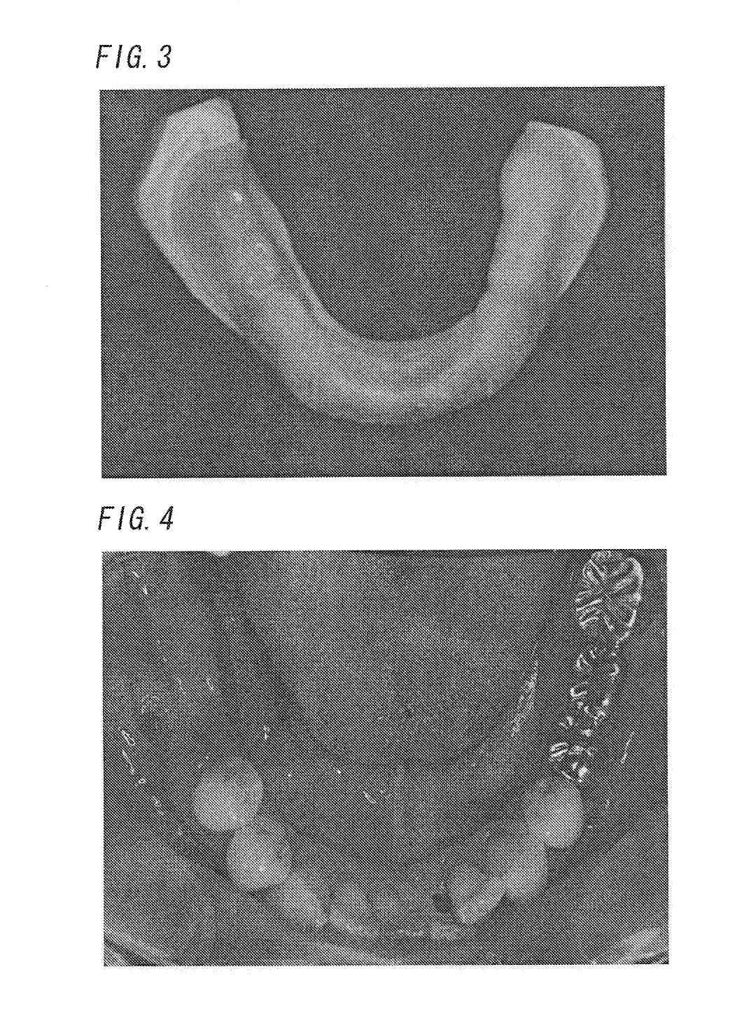

A shape of a tray 5 of thermoplastic resin, is not limited so long as the tray 5 of the thermoplastic resin can cover teeth 13. However, the tray 5 of the thermoplastic resin preferably has an inner shape to fit a shape of gums 12 and teeth 13. Moreover, the tray 5 of the thermoplastic resin preferably has a shape capable of covering a tooth cervix (i.e., a vicinity of a boundary between the tooth 13 and the gum 12) and the partial gums 12, and more preferably has a shape covering the tooth cervix and adjacent regions of the gums 12 extending from the tooth cervix by 1 to 6 mm (preferably 2 to 5 mm, and more preferably 3 to 4 mm). Besides, a shape (i.e., a whole shape viewed in an occlusal movement direction) of the fray 5 of the thermoplastic resin is preferably a U-shape corresponding to arrangement of the teeth 13 (the gum 12 corresponding to a space of a lost tooth is used as an alternative to the lost tooth), regardless of presence or absence of a tooth 13. Note that, if there is a loss of a tooth, a part, of the tray 5 of the thermoplastic resin corresponding to the space of the lost tooth preferably has an inner shape corresponding to the gum 12, and the tray 5 of the thermoplastic resin is more preferably provided with a prosthetic tooth 14 disposed correspondingly to the space of the lost tooth (see, FIGS. 1, 3, 22, 25, and 26). When the multilayer mouthpiece includes the prosthetic tooth 14, the prosthetic tooth 14 may be disposed on an inside of the tray 5 of the thermoplastic resin (i.e., between the rub stimulation sheet 6 and the tray 5 of the thermoplastic resin) or be disposed on an outside of the tray 5 of the thermoplastic resin, but is preferably disposed on the outside of the tray 5 of the thermoplastic resin (in any case, it is preferable that the prosthetic tooth 14 does not touch the gums 12 directly). Besides, when the prosthetic tooth 14 is provided, the prosthetic tooth 14 is preferably disposed such that the prosthetic tooth 14 has the same height as the user's teeth 13 at occlusion. Namely, the prosthetic tooth 14 is preferably little higher than the teeth 13 while not occluding,

When the prosthetic tooth 14 is disposed correspondingly to the space of the lost tooth, the prosthetic tooth 14 is preferably made of polymethyl methacrylate (PMMA) or the like. In this case, the prosthetic tooth 14 is preferably bonded to the tray 5 of the thermoplastic resin. The prosthetic tooth 14 and the tray 5 of the thermoplastic resin may be bonded to each other with using an adhesive, or by thermal fusion bonding or the like. Besides, to bond these, a primer 15 (i.e., a substance securing bond between these, for example, a polyethylene sheet) can be used.

The tray 5 of the thermoplastic resin may include a tray for an upper jaw and a tray for a lower jaw, which may fee provided as separate parts or may be connected integrally. Alternatively, the tray 5 of the thermoplastic resin may be composed of only a tray for a left or right jaw. Besides, the tray 8 of the thermoplastic resin may be connected to a grip designed to protrude outside the oral cavity.

The thermoplastic resin available for the tray 5 of the thermoplastic resin is not limited as long as it can be molded by heating. Examples of the thermoplastic resin include ethylene-vinyl, acetate copolymer (EVA), a polyolefin (e.g., polyethylene, polypropylene, polybutadiene. and copolymer composed of monomers thereof), polyvinyl acetate (PVA), and polyurethane elastomer. In the aforementioned resins, the thermoplastic resin is preferably ethylene-vinyl acetate copolymer (EVA), a polyolefin, or polyurethane elastomer, and is more preferably ethylene-vinyl acetate copolymer (EVA) or a polyolefin.

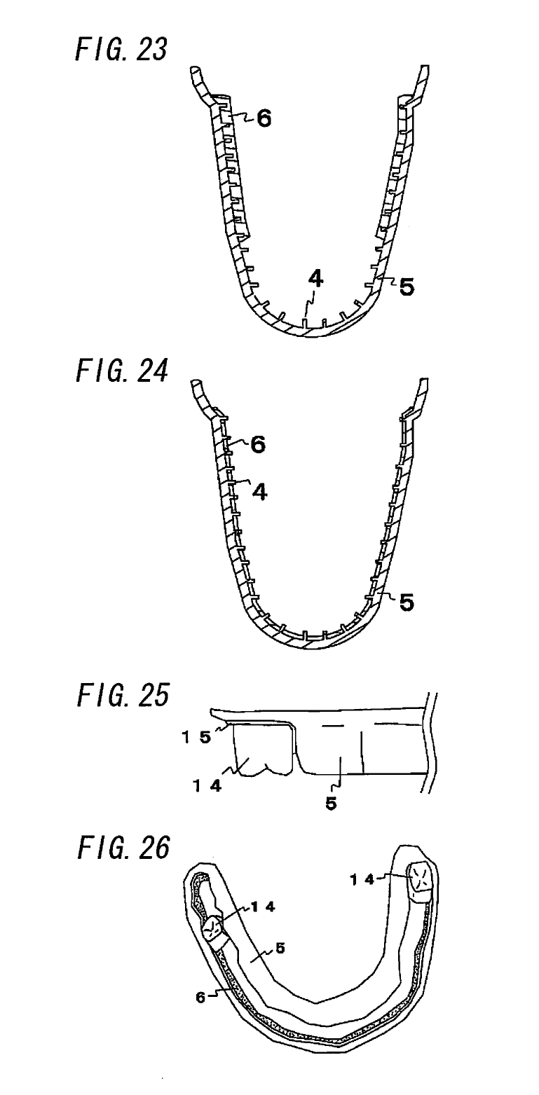

The rub stimulation sheet 6 is disposed on the inner surface of the tray 5 of the thermoplastic resin such that the rub stimulation sheet 6 is allowed to touch each of the teeth 13 and the gums 12. The rub stimulation sheet 6 may be disposed on the entire inner surface of the tray 5 of the thermoplastic resin (see, FIG. 24) or be disposed on a part of the inner surface of the tray 5 of the thermoplastic resin. When the rub stimulation sheet 6 is disposed on the part of the inner surface of the tray 5 of the thermoplastic resin, the rub stimulation sheet 6 is preferably disposed such that the rub stimulation sheet 6 is allowed to rub at least the gums 12 to supply stimulation to the gums 12. Namely, the rub stimulation sheet 6 is preferably disposed at least on an end (peripheral portion) which is far from a portion where the tray 5 of the thermoplastic resin is to be in contact with the top of the teeth 13 (see FIG. 23).

The rub stimulation sheet 6 is provided for the purpose of providing stimulation by rubbing the gums 12 (or the teeth 13 and gums 12) through chewing (tapping) or the like (that is, the rub stimulation sheet 6 can rub the gums 12 and the teeth 13 to supply stimulation to the gums 12 as well as to make the teeth 13 clean). A shape and material of the rub stimulation sheet 6 are not limited so long as the rub stimulation sheet 6 does not supply excess stimulation through rubbing to the gums 12, but the rub stimulation sheet 6 is preferably formed of foamed resin or nonwoven fabric, and is more preferably formed of foamed resin having open ceils (i.e., an open-cell foamed resin). The rub stimulation sheet 6 is most preferably formed of foamed melamine resin, foamed urethane, foamed polyolefin (e.g., foamed polyethylene, foamed polypropylene, and foamed (ethylene-vinyl) copolymer), or foamed poly-vinyl alcohol.

The rub stimulation sheet 6 has a thickness preferably falling within a range of 0.1 to 3 mm, and more preferably falling within a range of 0.2 to 2 mm. An amount of a movement (i.e., a movement amount) of the multilayer mouthpiece is adjusted by the thickness of the rub stimulation sheet 6. The movement of the multilayer mouthpiece will be described below.

The rub stimulation sheet 6 is on the inside of the tray 5 of the thermoplastic resin so as to be permanently fixed to the tray 5 of the thermoplastic resin. However, the rub stimulation sheet 6 may be detachably on the tray 5 of the thermoplastic resin. When the rub stimulation sheet 6 is detachably on the tray 5 of the thermoplastic resin, it is possible to exchange the rub stimulation sheet 6 with new one when the rub stimulation sheet 6 deteriorates or becomes dirty.

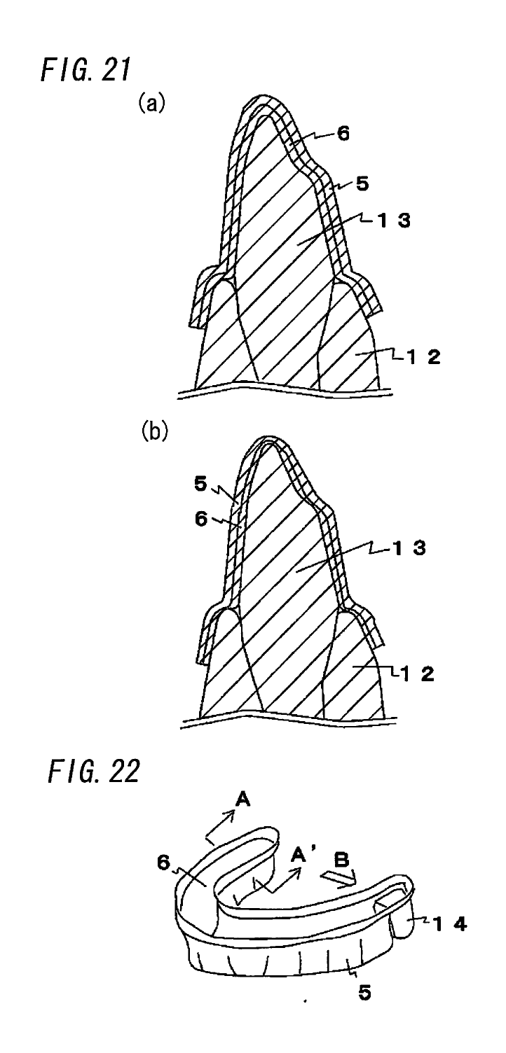

A sheet 2 of the thermoplastic resin and/or the rub stimulation sheet 6 is preferably an elastic body, and more preferably made of the preferable material described above. When the rub stimulation sheet 6 is the elastic body, stimulation by rubbing is more uniformly supplied to the gums 12 (or the gums 12 and teeth 13) through chewing (tapping) or the like. Namely, when tipper and lower teeth occlude through chewing (tapping) or the like, parts of the rub stimulation sheet 6 and the tray 5 of the thermoplastic resin winch touch the top of the teeth 13 are compressed, and therefore the whole multilayer mouthpiece moves so as to approach the teeth 13 (see, FIG. 21(b)). Moreover, when the upper and lower teeth, stop occluding, the compressed rub stimulation sheet 6 and the tray 5 of the thermoplastic resin are released and returned to have original thicknesses, and therefore the multilayer mouthpiece moves so as to be away from the teeth 13 (see, FIG. 21(a)). When the multilayer mouthpiece moves in this way, the rub stimulation sheet 6, which touches the gums 12 and the top and side portion of the teeth 13, rubs the gums 12 (or the gums 12 and teeth 13) to supply stimulation to the gums 12 (or the gums 12 and teeth 13). Namely the multilayer mouthpiece in accordance with the present invention can move upward and downward relative to the gums 12 (or the gums 12 and teeth 13), and therefore can effectively rub the gums 12 for the gums 12 and teeth 13) to supply stimulation thereto.

The tray 5 of the thermoplastic resin may be provided with a protrusion(s) 4 on a gum side (or the gum and tooth side) of the tray 5 of the thermoplastic resin. When the protrusion 4 is provided, the rub stimulation sheet 6 rubs the gums 12 (or the gums 12 and teeth 13) to provide the stimulation thereto and additionally the protrusion 4 rubs the gums 12 (or the gums 12 and teeth 13) to provide stronger stimulation thereto. Besides, the protrusion 4 itself functions as a spring, and therefore facilitates more a movement of the multilayer mouthpiece.

The protrusions 4 may penetrate the rub stimulation sheet 6 such that the protrusions 4 can rub the gums 12 (or the gums 12 and/or the teeth 13) directly to supply stimulation thereto (see, FIG. 24). Alternatively the protrusions 4 may be covered with the rub stimulation sheet 6 (see, FIG. 23).

The number, the position, and the shape of the protrusions 4 are arbitrarily set. The protrusion 4 is preferably provided such that the protrusion 4 can rub at least a tooth cervix to supply stimulation to the tooth cervix, and is more preferably provided so that the protrusion 4 can rub an interdental papilla (a portion of the gum 12 between the teeth 13) to supply stimulation to the interdental papilla. When the protrusion 4 is provided in such a manner to rub the tooth cervix to supply stimulation thereto, it is possible to enlarge a periodontal pocket more and therefore to facilitate injection of a drug described below into this periodontal pocket (that is, the multilayer mouthpiece works as a drag retainer) as well as it is possible to more rub a part of the gum 12 close to the periodontal pocket: to simply stimulation thereto. Hence, the multilayer mouthpiece can be more effective in remedying and preventing the periodontal disease and the like. In particular, stimulation by rubbing to the interdental papilla can further tone up the gums 12 and reduce a size of the periodontal pocket, and therefore is much more effective in suppressing breeding of the periodontal disease bacterium, which is anaerobe.

It is not necessary that the protrusions 4 have the same length. For example, the lengths of the protrusions 4 may be selected according to positions such as a position to be close to the top of teeth 13 and a position to be close to the tooth cervix. Specifically, protrusions 4 provided on a portion to be in contact with the top of the teeth 13 may have a greater length, and protrusions 4 positioned closer to the end (peripheral portion) may have shorter lengths (see, FIGS. 23 and 24).

In the multilayer mouthpiece in accordance with the present invention, a part of or a whole portion to be in contact with the top of the teeth 13 may be removed to make an opening in the multilayer mouthpiece. When the opening is formed by removing the whole portion to be in contact with the top of the teeth 13, at least two of prosthetic teeth 14 are preferably provided on the multilayer mouthpiece (see, FIG. 26). Namely, when there is no loss of the teeth 13, the multilayer mouthpiece cannot include the prosthetic tooth 14, and therefore it is not preferable to remove the whole portion to be in contact with the top of the teeth 13. When the multilayer mouthpiece includes the opening, a movable range of jaws is narrowed by the thickness of the multilayer mouthpiece, and the both jaws can occlude to a similar extent to a case where the multilayer mouthpiece is not worn. Note that when the opening is too large, the multilayer mouthpiece is likely to move too greatly and therefore is unlikely to return to the initial position, and consequently there is a possibility that the run stimulation sheet 6 fails to provide enough stimulation by rubbing. Therefore, it is preferable that the opening has a minimum size corresponding to the top of the teeth 13.

Supplying stimulation by rubbing to the gums 12 (or the gums 12 and the teeth 13) through chewing (tapping) or the like with the multilayer mouthpiece in accordance with the present invention is effective in prevention and treatment of the periodontal disease or the like (because supplying stimulation by rubbing to the gums 12 tones up the gums 12 and reduces the size of the periodontal pocket, and therefore is effective in suppressing breeding of the periodontal disease bacterium, which is anaerobe), as well as provides an effect of making the teeth 13 clean (brushing the teeth 13; making the surface of the teeth 13 clean and removing plaques). For a person requiring long-term care who has a difficulty in brushing his or her teeth 13, the multilayer mouthpiece can facilitate rubbing the gums 12 (or the teeth 13 and gums 12) to supply stimulation as well as brushing the teeth 13. Moreover, repetition of chewing (tapping) can promote secretion of saliva and make a chewing force improved. The multilayer mouthpiece in accordance with the present invention is suitable for rehabilitation of a person requiring long-term care, too.

The multilayer mouthpiece can provide such an effect, to serve as a drug retainer (a teeth tray that is a carrier for transporting a drug locally to the surface of the teeth 13 and/or the gums 12) with the rub stimulation sheet 6 containing a desired drug.

Examples of the drug include generally-used dental drugs (e.g., dentifrice, a fluorinating agent, disinfectant and bleach; for example, hypochlorous acid water, strong acid water, chlorohexidine, isodine, ozone water, and chloro dioxide water). With using the drug together, the multilayer mouthpiece can provide an effect of stimulation by rubbing through chewing (tapping) as well as can keep the effect of the drug for a long time.

A method of manufacturing the multilayer mouthpiece in accordance with the present invention is not limited so long as the multilayer mouthpiece includes: the tray 5 of the thermoplastic resin for covering the teeth 13; and the rub stimulation sheet 6 which is on the tray 5 and is for rubbing the gums 12 (or the gums 12 and the teeth 13) to supply stimulation. Preferably the manufacturing method for the multilayer mouthpiece includes: a step of preparing a plaster cast 1 by impression taking: and a heating and pressure molding step of performing heat and pressure molding while covering the plaster cast 1 with the rub stimulation sheet 6 and a sheet 2 of the thermoplastic resin in such a manner that the rub stimulation sheet 6 is in contact with the piaster cast 1.

The step of preparing the plaster cast 1 by impression taking may be a conventional method performed in dentistry. Besides, by use of data of types of teeth 13 and gums 12 obtained by impression taking, a plaster cast 1 with an average size may be prepared. Specifically, the plaster casts 1 with sizes of S, M, L and the like may be prepared as the plaster casts 1 suitable for Japanese people. Furthermore, a metal mold instead of the plaster cast 1 with the average size may be prepared. When the metal mold is used, an injection molding method is available. For example, adopted may be a method including steps of placing the rub stimulation sheet 6 on the metal mold; and subsequently the thermoplastic resin is injection-molded such that the tray 5 of the thermoplastic resin and the rub stimulation sheet 6 are stacked. The multilayer mouthpiece in accordance with the present invention is not limited to a custom-made product which is prepared by impression taking for a particular person, and is a general product prepared for unspecified users.

FIG. 20 shows the multilayer mouthpiece prepared with the plaster cast 1 having an average size. FIG. 20 does not show the shape corresponding to the tooth cervix and the interdental papilla and the like. However, the multilayer mouthpiece may have the shape corresponding to the tooth cervix and/or the interdental papilla with regard to the average shape.

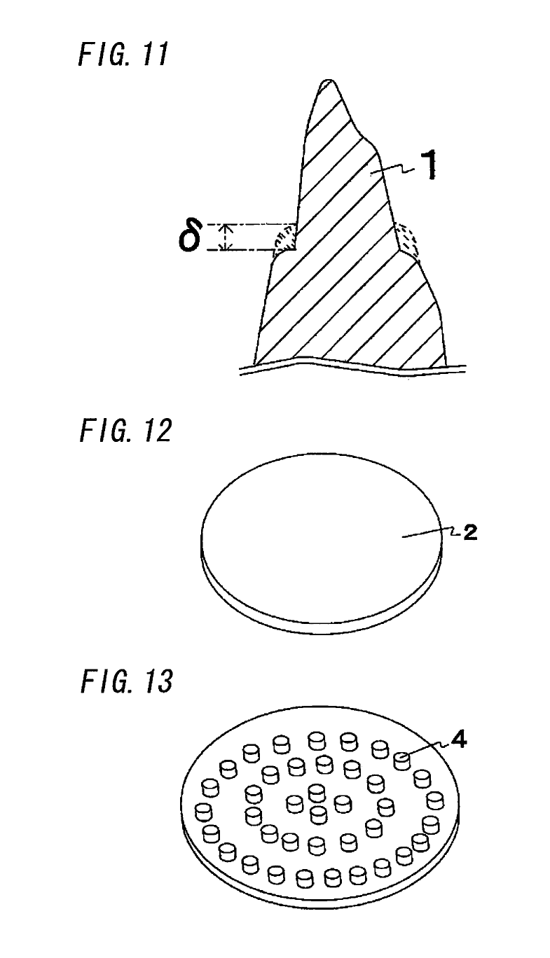

The step of preparing the plaster cast 1 by impression taking may include a step of preparing the plaster cast 1 by trimming a gum portion of a model formed by impression taking in such a manner to more expose the teeth of the plaster cast 1 (see, FIG. 11; a wavy line part indicates the part which has been removed). When the plaster cast 1 is prepared by trimming the gum portion of the model formed by impression taking in such a manner to more expose the teeth of the plaster cast 1, the multilayer mouthpiece (particularly in parts to be in contact with the teeth 13 and the gums 12) is consequently a bit different in size from the model prepared by impression taking, and therefore such a difference may cause stronger stimulation by rubbing to the tooth cervix. Besides, the difference may cause a more increase in the size of the periodontal pocket, and therefore the drug can be given easily to the periodontal pocket (that is, the multilayer mouthpiece works as the drag retainer). Hence, the multilayer mouthpiece can be more effective in remedying and preventing the periodontal disease and the like.

An amount of removal of the gum portion is arbitrarily selected in accordance with a user, but a height, (a length δ of an arrow in FIG. 11) of the gum 12 being in contact with the tooth 13 preferably falls within a range of about 0.1 mm to about 3 mm, more preferably falls within a range of about 0.2 mm to about 2 mm, and much more preferably falls within a range of about 0.3 mm to about 1 mm.

The heating and pressure molding step of performing heat and pressure molding while covering the piaster cast 1 with the rub stimulation sheet 6 and the sheet 2 of the thermoplastic resin in such a manner that the rub stimulation sheet 6 is in contact with the plaster cast 1 may be the same methods for preparing a mouthguard. for sports or the like except for a step of covering the plaster cast 1 with the rub stimulation sheet 6 and the sheet 2 of the thermoplastic resin in such a manner that the rub stimulation sheet 6 is in contact with the plaster cast 1 (as a reference, methods described in JP 2010-22685 A, and “Saishin 3DS Kankyo Ushoku Stage Perio Stage” Dentaldiamond, CO. LTD. Published on 1 Jul., 2009, and the like). Examples of heat pressure molding machinery include a vacuum molding machine (Airbag XQ, Vacuum adapter 1-type or the like; available from Yamahachi dental Mfg., Co.), the BioStar series and the minister series (available from Scheu-Dental GmbH).

The rub stimulation sheet 6 may be flat, or a three-dimensional rub stimulation sheet 6 that is preliminarily shaped (e.g., a sheet shaped into a U-shaped semi-cylinder). The rub stimulation sheet 6 may include a slit. With using the three-dimensional rub stimulation sheet 6 or the like that is preliminarily shaped, it can be prevented that winkles occur on the rub stimulation sheet 6 through heating for molding and that the rub stimulation sheet 6 is partly extended so as to be thin. Namely, with using the three-dimensional rub stimulation sheet 6 or the like that is preliminarily shaped, obtained can be the multilayer mouthpiece including the uniform rub stimulation sheet 6.

The heating and pressure molding step may include steps “X” of heating a face, to be heated, of the sheet 2 of the thermoplastic resin to have a softening temperature with a heater 9; and subsequently covering the rub stimulation sheet 6 with the sheet 2 of the thermoplastic resin in such a manner that the face (heated face) of the sheet 2 of the thermoplastic resin is in contact with the rub stimulation sheet 6 which is placed to cover the piaster cast 1; and molding the sheet 2 of the thermoplastic resin and the rub stimulation sheet 6 by pressing. Alternatively the heating and pressure molding step may include steps “Y” of: heating a face, to be heated, of the sheet 2 of the thermoplastic resin to have a softening temperature with a heater 9; and subsequently covering the rub stimulation sheet 6 on the face (heated face) of the sheet 2 of the thermoplastic resin and pressing the rub stimulation sheet 6 and the sheet 2 of the thermoplastic resin to prepare a multilayer sheet; and thereafter covering the plaster cast 1 with the multilayer sheet in such a manner that the sheet 2 of the thermoplastic resin of the multilayer sheet is in contact with the plaster cast 1; and molding the multilayer sheet by heating and pressing. Each set of the above steps is affected by structure and function of the manufacturing device for heat pressure molding. Namely, the aforementioned steps “X” and “Y” can be used with using the manufacturing device in accordance with the present invention described below as well as the BioStar series and MiniStar series (available from Scheu-Dental GmbH). In contrast, it is preferable that the steps “Y” are selected with using a vacuum molding machine (Airbag XQ, Vacuum adapter 1-type or the like; available from Yamahachi dental Mfg., Co.).

The sheet 2 of the thermoplastic resin and the rub stimulation sheet 6 may be preliminarily stacked and used as a. laminated sheet. Such a laminated sheet is obtained by the steps “Y” described above. Moreover, this laminated sheet may be molded by heating and pressing in the manner in the steps “Y”. The sheet 2 of the thermoplastic resin maybe provided with the protrusion (s) 4.

The laminated sheet may be flat, or a three-dimensional laminated sheet that is preliminarily shaped (e.g., a laminated sheet shaped into a U-shaped hemi-cylinder). The laminated sheet may include a slit. With using the three-dimensional laminated sheet or the like that is preliminarily shaped, it can be prevented that winkles are formed on the laminated sheet (particularly the rub stimulation sheet 6) through molding by heating and that the laminated sheet (particularly the rub stimulation sheet 6) is partly extended so as to be thin. Namely, with using the three-dimensional laminated sheet or the like that is preliminarily shaped, the multilayer mouthpiece including the uniform rub stimulation sheet 6 is easily obtained.

The sheet 2 of the thermoplastic resin has a thickness that preferably falls within a range of 0.5 mm to 3 mm and that more preferably falls within a range of 1 mm to 2 mm.

As the sheet 2 of the thermoplastic resin, a thermoplastic resin sheet 2 with the protrusion(s) 4 may be used. Using the thermoplastic resin sheet 2 with the protrusion 4 facilitates manufacture of the multilayer mouthpiece including the tray 5 of the thermoplastic resin and the protrusion 4 on the tooth side of the tray 5 of the thermoplastic resin.

The thermoplastic resin sheet 2 with the protrusions 4 may be prepared by placing a thermoplastic resin sheet 2 on a mold 3 with dimples formed thereon correspondingly to the desired number and position of the protrusions 4, and subsequently molding by heating (see, FIGS. 12 and 13).

When the thermoplastic resin sheet 2 with the protrusions 4 is used, the rub stimulation sheet 6 may have through-holes 7 corresponding to the number and position of the protrusions 4. In this case, if molding is performed by heating while the protrusions 4 are inserted into the through-holes 7, manufactured is the multilayer mouthpiece with the protrusions 4 disposed so as to penetrate the rub stimulation sheet 6 for directly rubbing the gums 12 and/or the teeth 13 to supply stimulation thereto. In contrast, with not making the through-hole 7 in the rub stimulation sheet 6, the multilayer mouthpiece having the protrusion 4 covered with the rub stimulation sheet 6 may be manufactured. Alternatively the rub stimulation sheet 6 may include some through-holes 7 corresponding to the number and position of protrusions 4, and include some through-holes 7 which are not corresponding to the protrusions 4. In this case, manufactured is the multilayer mouthpiece including some protrusions 4 that can rub the gums 12 and/or the teeth 13 directly to supply stimulation thereto and the other protrusions 4 covered with the rub stimulation sheet 6.

The multilayer mouthpiece including the tray 5 of the thermoplastic resin provided with the protrusions 4 on the tooth side of the tray 5 thermoplastic resin is manufactured easily with a method of using the thermoplastic resin sheet 2 with the protrusions 4. However, the manufacturing method is not limited to this method, and alternative methods are available for facilitating manufacture.

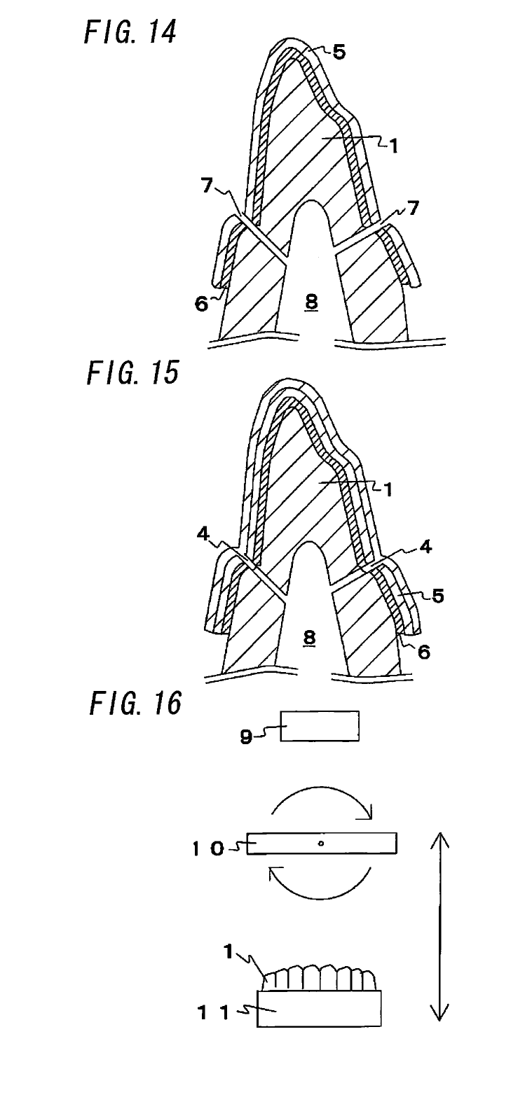

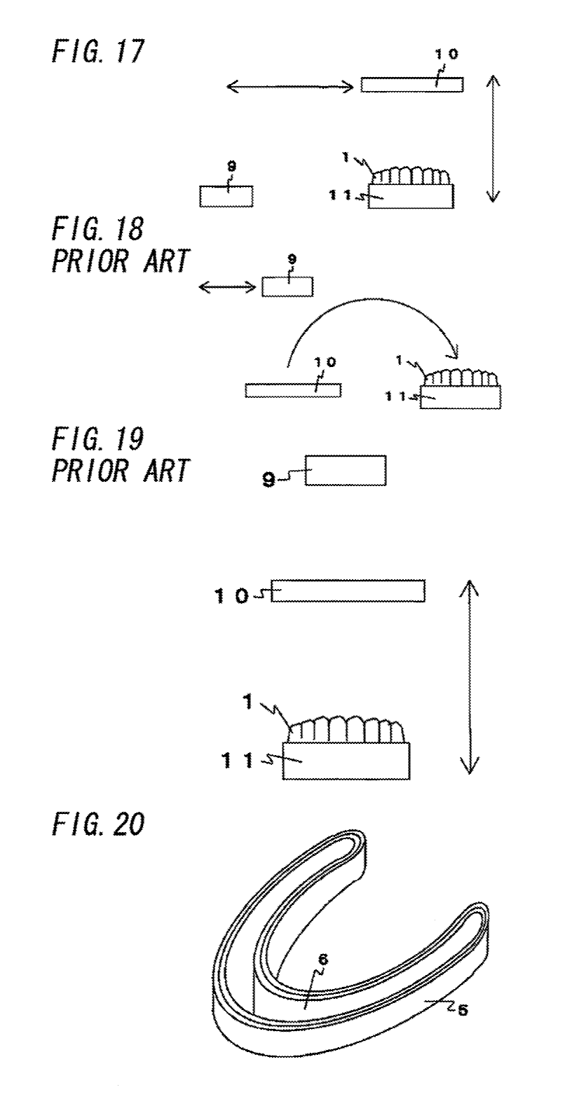

Examples of the alternative methods include a method composed of steps, subsequent to the heating and pressure molding step, of: making the through-hole 7 in the rub stimulation sheet 6 and the sheet 2 of the thermoplastic resin (see, FIG. 14); and subsequently placing another sheet 2 of the thermoplastic resin on the sheet 2 of the thermoplastic resin having the through-hole 7; and molding the sheets of the thermoplastic resin by heating to form protrusion(s) 4 on the tooth side; of the tray 5 of the thermoplastic resin, the protrusion 4 penetrating the rub stimulation sheet 6 for directly rubbing the gums 12 and/or the teeth 13 to supply stimulation thereto (see, FIG. 15).

In the step of making the through-hole 7 and forming the protrusion 4 subsequent to the heating and pressure molding step, it is preferable to make a hole in the plaster cast 1 at the time of making the through-hole 7 in the sheet 2 of the thermoplastic resin and the rub stimulation sheet 6. It is preferable that the plaster cast 1 includes a cavity 8 in the inside thereof and the hole in the plaster cast 1 communicates with the cavity 8 (see, FIGS. 14 and 15). Then, the cavity may be depressurized in the step of molding the thermoplastic sheet having the through-hole 7 and another thermoplastic sheet placed thereon. With depressurizing the cavity 8, it is possible to facilitate pressing the softened thermoplastic resin into the through-hole 7. If the protrusion 4 prepared in this manner has a length greater than a predetermined length, the protrusion 4 may be cut arbitrarily.

The manufacturing device for manufacture of the multilayer mouthpiece in accordance with the present invention is not limited, and examples of the manufacturing device include the aforementioned device which can perform molding by heating. In addition to the manufacturing devices commercially available, the following manufacturing devices may be available, for example.

<Manufacturing Device 51>

The manufacturing device 51 is a manufacturing device for the aforementioned multilayer mouthpiece including: a heater 9 for heating a face, to be heated, of the sheet 2 of the thermoplastic resin to a softening temperature; and a holding arm 10 configured to hold the sheet 2 of the thermoplastic resin and to reverse the face of the sheet 2 of the thermoplastic resin; and a table 11 for fixing a plaster cast 1. The manufacturing device 51 is configured such that: the heater 9, the holding arm 10, and the table 11 are arranged in this order from the face (heated face) of the sheet 2 of the thermoplastic resin along a vertical direction to the face of the sheet 2 of the thermoplastic resin; and the holding arm 10 and the table 11 are configured to approach each other (see, FIG. 16).

Examples of the heater 9 include conventional heaters or the like, such as a sheathed heater, a near infrared heater, a far infrared heater, and a halogen heater.

The holding arm 10 is not limited so long as the holding arm 10 can hold the sheet 2 of the thermoplastic resin from the time when beating for molding starts to the time when molding (including cooling) completes and can reverse the heated face of the sheet 2 of the thermoplastic resin. Note that, the term “reverse” means that “invert something by 180 degrees”.

The table 11 is not limited so long as the table 11 can fix the plaster cast 1. Note that, in order to support any plaster cast 1, the table 11 may be configured so that a table angle can be adjusted.

The heater 9, the holding arm 10, and the table 11 are arranged in this order from the face (heated face) of the sheet 2 of the thermoplastic resin along a vertical direction to the face of the sheet 2 of the thermoplastic resin. Moreover, the holding arm 10 and the table 11 are configured to approach each other. In this regard, only the holding arm 10 may move, only the table 11 may move, or both of the holding arm 10 and the table 11 may move.

<Manufacturing Device 52>

The manufacturing device 52 is a manufacturing device for the aforementioned multilayer mouthpiece including: a heater 9 for heating a face, to be heated, of the sheet 2 of the thermoplastic resin to a softening temperature; and a holding arm 10 is configured to move on a virtual plane parallel to the face with holding the sheet 2 of the thermoplastic resin; and a table 11 for fixing a plaster cast 1. The manufacturing device 52 is configured such that; the holding arm 10 is further configured to move between a position in the virtual plane lacing the heater 9 and a position in the virtual plane facing the table 11; and the holding arm 10 and the table 11 are configured to approach each other while the holding arm 10 is in the position in the virtual plane facing the table 11.

The heater 9 and the table 11 are the same as those described above. The holding arm 10 is not limited so long as the holding arm 10 can move on the virtual plane parallel to the heated face with holding the sheet 2 of the thermoplastic resin. Note that, the virtual plane is a plane parallel to the face (heated face) of the sheet 2 of the thermoplastic resin held by the holding arm 10, and means an imaginary plane which is not in reality.

In the virtual plane, the holding arm 10 is configured to move between a position facing the heater 9 and a position facing the table 11. Note that, the position feeing the heater 9 refers to a position in which the heater 9 is present along a vertical direction to the heated face of the sheet 2 of the thermoplastic resin on the virtual plane. The position facing the table 11 refers to a position in which the table 11 is present along the vertical direction to the heated face of the sheet 2 of the thermoplastic resin on the virtual plane.

The holding arm 10 and the table 11 are configured to approach each other while the holding arm 10 is in the position facing the table 11. In this regard, only the holding arm 10 may move, only the table 11 may move, or both of the holding arm 10 and the table 11 may move.

In order to make comparison with the relative positions and the movements of the heater 9, the holding arm 10, and the table 11 in the manufacturing device in accordance with the present invention, FIGS. 18 and 19 show conceptual diagrams schematically illustrating the relative positions and the movements (arrows indicate directions of the movements) of the heaters 9, the holding arms 10, and the tables 11 in a manufacturing device (H1) (BioStar series MiniStar series available from Scheu-dental GmbH; FIG. 18) and a manufacturing device (H2) (a vacuum molding machine (Airbag XQ, Vacuum adapter I-type or the like: available from Yamahachi dental Mfg., Co.; FIG. 19)) which are commercially available.

The multilayer mouthpiece in accordance with the present invention is suitable for a general mouthguard (e.g., night guard, sports guard, an occlusal sprint, a sleep sprint, and hemostasia). When the multilayer mouthpiece is used as the night guard, the sports guard, the occlusal sprint, or the sleep sprint, the multilayer mouthpiece can cushion the teeth 13 from a load, and moreover, enables attachment for a long time since, even when the shape of the tooth 13 is changed due to cure of a tooth 13, dental prosthesis, fill, or fracture of a tooth 13, the multilayer mouthpiece can fit the shape of the teeth 13 that is changed. When the multilayer mouthpiece is used as hemostasia, the multilayer mouthpiece can provide a drug as well as fit the gum 12 of which the shape changes after tooth extraction. The multilayer mouthpiece in accordance with the present invention can be applied to animals with teeth 13 and gums 12 (e.g., animals in a zoo or kept as a pet), in addition, to humankind.

### EXAMPLES

### Example 1

A plaster cast 1 was prepared by taking an impression of a patient “A” (39 years old, woman) with the periodontal disease. Thereafter, the plaster cast 1 was covered with a rub stimulation sheet 6 (a foamed melamine sheet “Basotect” with a thickness of about 1.5 mm available from BASF Japan Ltd. where “Basotect” is the registered trademark of BASF soeietas europaea) such that the rub stimulation sheet 6 touches the plaster cast 1, and then the rub stimulation, sheet 6 was covered with a sheet 2 of thermoplastic resin (an ethylene-vinyl acetate copolymer sheet “Bioplast” with a thickness of 1.5 mm available from s Scheu-Dental GmbH), and thereafter the sheets were molded by heating at 220° C. for 50 seconds with the heating and pressure molding machine (BioStar type-IV, available from Scheu-Dental GmbH; under 5 atm) and then cooling for 60 seconds. Thereafter, the molded sheets were taken, out from the plaster cast 1, and trimmed by removing unwanted parts, and consequently the multilayer mouthpiece 21 in accordance with the present invention was obtained.

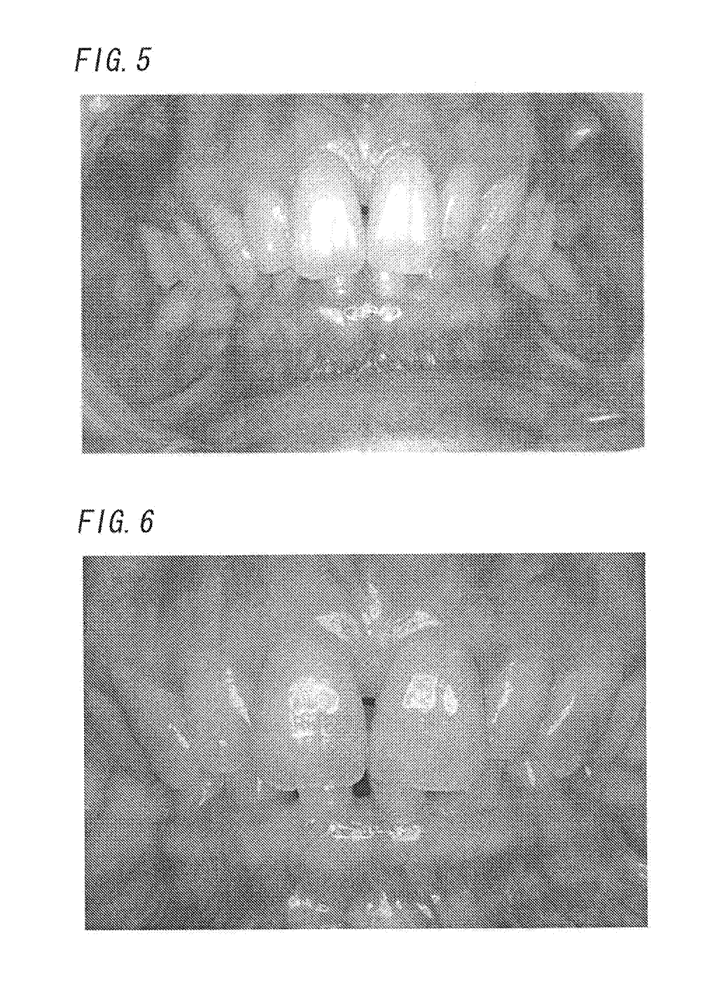

The patient “A” with the periodontal disease performed the following action for about two months every day. In this action, the patient “A” impregnated the rub stimulation sheet 6 of the multilayer mouthpiece 21 in accordance with the present invention with a hypochlorous acid aqueous solution of 250 ppm and thereafter wore the multilayer mouthpiece, and then repeated chewing (tapping) for 1 min. The number of P. gingivalis was measured before and after attachment of the multilayer mouthpiece 21 in accordance with the present invention with the PCR-Invader method. Table 1 shows the result. Besides, the FIGS. 5 to 8 are photographs that show labial surfaces of teeth 13 of upper and lower jaws (Patient “A”) and the tooth 13 No. 36 and the surrounding area and are taken before and after 2 months attachment of the multilayer mouthpiece, respectively.

TABLE 1
Patient “A”, Examination material: Paper point, Tooth No. 36

| | | |
|---|---|---|
| Before | Total of main bacterium in oral cavity | 1,400,000 |
| Attachment | P. gingivalis | 3,300 |
| | Ratio of P. gingivalis to the total of main | 0.24% |
| | bacterium | |
| After | Total of main bacterium in oral cavity | 25,000 |
| Attachment | P. gingivalis | loss than 10 |
| | Ratio of P. gingivalis to the total of main | 0% |
| | bacterium | |

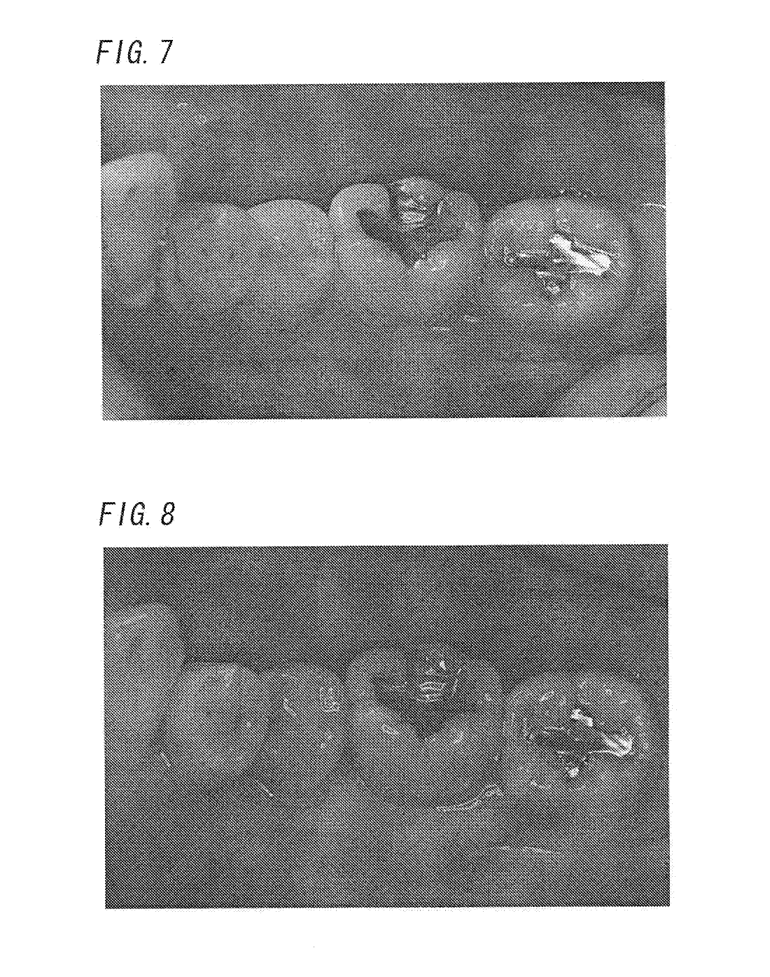

The number of P. gingivals was remarkably reduced owing to about 2 months attachment of the multilayer mouthpiece 21 in accordance with the present invention. Moreover, comparison between FIGS. 5 and 6 teaches that inflammation of the gums 12 close to the mandibular labial surface edge is remarkably reduced, and comparison between FIGS. 7 and 8 teaches that inflammation of the gum 12 between the teeth 13 No. 36 and No. 38 is reduced.

### Example 2

A plaster cast 1 was prepared by taking an impression of a patient “8” (31 years old, woman) with the periodontal disease. The plaster cast 1 was covered with a rub stimulation sheet 6 (a foamed melamine sheet. “Basotect” with a thickness of about 1.5 mm available from BASF Japan Ltd. where “Basotect” is the registered trademark of BASF soeietas europaea) such that the rub stimulation sheet 6 touches the plaster cast 1, and then the rub stimulation sheet 6 was covered with a sheet 2 of thermoplastic resin (an ethylene-vinyl acetate copolymer sheet “Bioplast” with the thickness of 1.5 mm available from s Scheu-Dental GmbH), and thereafter the sheets were molded by heating at 220° C. for 50 seconds with the heating and pressure molding machine (BioStar type-IV, available from Scheu-Dental GmbH; under 5 atm) and then cooling for 60 seconds. Thereafter, the molded sheets were taken out from the plaster cast 1, and trimmed by removing unwanted parts, and consequently, the multilayer mouthpiece 22 in accordance with the present invention was obtained.

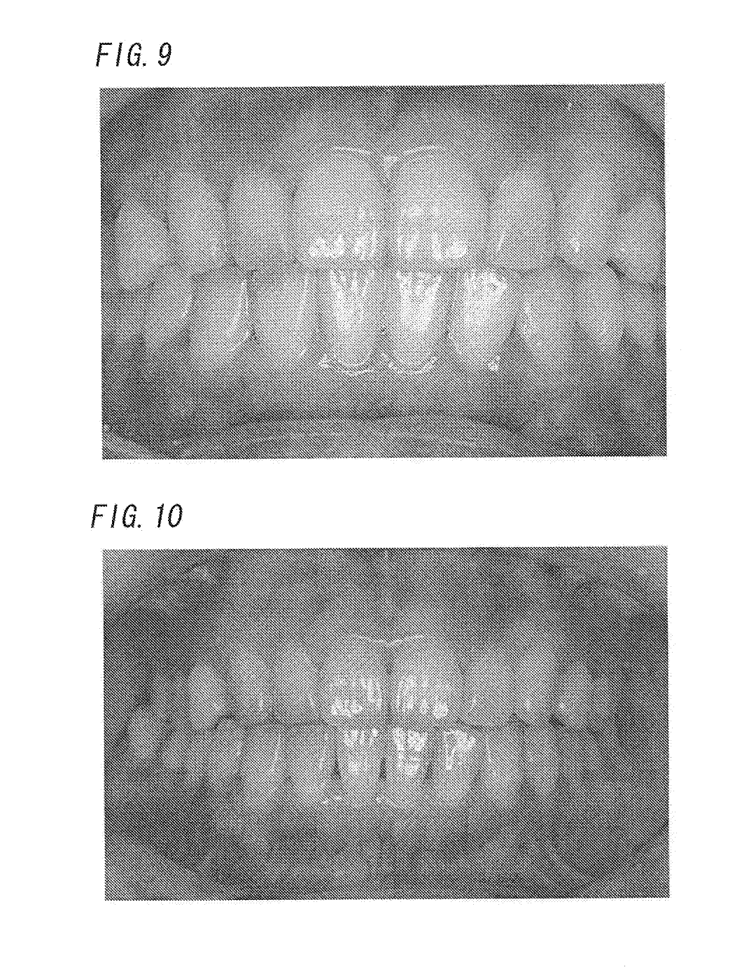

The patient “B” with the periodontal disease performed the following action for about three months every day. In this action, the patient “B” impregnated the rub stimulation sheet 6 of the multilayer mouthpiece 22 in accordance with the present invention with a hypochlorous acid aqueous solution of 250 ppm and thereafter wore the multilayer mouthpiece and then repeated chewing (tapping) for 1 min. Then, the number of P. gingivalis was measured before and after attachment of the multilayer mouthpiece 22 in accordance with the present invention with the PCR-Invader method. Table 2 shows the result. Besides, the FIGS. 9 and 10 are photographs that show labial surfaces of upper and lower jaws and are taken before and after about 3 months attachment of the multilayer mouthpiece, respectively.

TABLE 2
Patient “B”, Examination material: Paper point, Tooth No. 37

| | | |
|---|---|---|
| Before | Total of main bacterium in oral cavity | 1,300,000 |
| Attachment | P. gingivalis | 1,200 |
| | Ratio of P. gingivalis to the total of main | 0.92% |
| | bacterium | |
| After | Total of main bacterium in oral cavity | 1,000 |
| Attachment | P. gingivalis | less than 10 |
| | Ratio of P. gingivalis to the total of main | 0% |
| | bacterium | |

The number of P. gingivalis was remarkably reduced owing to about 3 months attachment of the multilayer mouthpiece 22 in accordance with the present invention. Moreover, comparison between FIGS. 9 and 10 teaches that inflammation of the gums 12 close to the mandibular labial surface edge is remarkably reduced.

### Example 3

A plaster cast 1 was prepared by taking an impression of a patient “C” (38 years old, woman) with the periodontal disease. The plaster cast 1 was covered with a rub stimulation sheet 6 (a foamed melamine sheet “Basotect” with a thickness of about 1.5 mm available from BASF Japan Ltd. where “Basotect” is the registered trademark of BASF societas europaea) such that the rub stimulation sheet 6 touches the plaster cast 1, and then the rub stimulation, sheet 6 was covered with a sheet 2 of thermoplastic resin (an ethylene-vinyl acetate copolymer sheet “Bioplast” with the thickness of 1.5 mm available from s Scheu-Dental GmbH), and thereafter the sheets were molded by heating at 220° C. for 50 seconds with the heating and pressure molding machine (BioStar type-IV, available from Scheu-Dental GmbH; under 5 atm) and then cooling for 60 seconds. Thereafter, the molded sheets were taken out from the plaster cast 1, and trimmed by cutting away unwanted parts, and consequently, the multilayer mouthpiece 23 in accordance with the present invention was obtained.

The patient “C” with the periodontal disease performed the following action for about four months every day. In this action, the patient “C” impregnated the rub stimulation sheet 6 of the multilayer mouthpiece 23 in accordance with the present invention with a hypochlorous acid aqueous solution of 250 ppm and thereafter wore the multilayer mouthpiece and then repeated chewing (tapping) for 1 min. Then, the number of P. gingivalis was measured before and after attachment of the multilayer mouthpiece 23 in accordance with the present invention with the PCR-Invader method. Table 3 shows the result.

TABLE 3
Patient “C”, Examination material: saliva

| | | |
|---|---|---|
| Before | Total of main bacterium in oral cavity | 1,300,000 |
| Attachment | P. gingivalis | 1,200 |
| | Ratio of P. gingivalis to the total of main | 0.92% |
| | bacterium | |
| After | Total of main bacterium in oral cavity | 1,000 |
| Attachment | P. gingivalis | less than 10 |
| | Ratio of P. gingivalis to the total or main | 0% |
| | bacterium | |

The number of P. gingivalis was remarkably reduced owing to about 4 months attachment of the multilayer mouthpiece 28 in accordance with the present invention.

### REFERENCE TO SIGNS LIST

1 Plaster cast
2 Sheet of thermoplastic resin
3 Mold with dimple
4 Protrusion
5 Tray of thermoplastic resin
6 Rub stimulation sheet
7 Through-hole
8 Cavity
9 Heater
10 Holding arm
11 Table
12 Gum
13 Tooth
14 Prosthetic tooth
15 Primer (Polyethylene sheet)

1. A multilayer mouthpiece comprising:
a tray of thermoplastic resin for covering teeth; and
a rub stimulation sheet for rubbing gums to supply stimulation to the gums, the rub stimulation sheet being on the tray of the thermoplastic resin.

2. The multilayer mouthpiece as set forth in claim 1, wherein
the rub stimulation sheet is formed of foamed resin or nonwoven fabric.

3. The multilayer mouthpiece as set forth in claim 1, wherein
the rub stimulation sheet is formed of foamed resin having open cells.

4. The multilayer mouthpiece as set forth in claim 3, wherein
the foamed resin is selected from a group consisting of foamed melamine resin, foamed urethane, foamed polyolefin, and foamed poly-vinyl alcohol.

5. The multilayer mouthpiece as set forth in claim 1, wherein
the thermoplastic resin is ethylene-vinyl acetate copolymer (EVA).

6. The multilayer mouthpiece as set forth in claim 1, further comprising a prosthetic tooth on the tray of the thermoplastic resin correspondingly to a space of a lost tooth.

7. (canceled)

8. The multilayer mouthpiece as set forth in claim 1, wherein
the rub stimulation sheet contains a drug so as to serve as a drug retainer.

9. (canceled)

10. The multilayer mouthpiece as set forth in claim 1, wherein:
the tray of the thermoplastic resin includes a tray of the thermoplastic resin for covering teeth on an upper jaw and a tray of the thermoplastic resin for covering teeth on a lower jaw, which are connected to each other.

11. The multilayer mouthpiece as set forth in claim 1, wherein
the tray of the thermoplastic resin is provided with a protrusion on a tooth side thereof.

12. The multilayer mouthpiece as set forth in claim 11, wherein
the protrusion penetrates the rub stimulation sheet for directly rubbing the gums and/or the teeth to supply stimulation thereto.

13. The multilayer mouthpiece as set forth in claim 11, wherein
the protrusion is disposed so as to rub an interdental papilla to supply stimulation to the interdental papilla.

14. A manufacturing method for the multilayer mouthpiece as set forth in claim 1, comprising;
a step of preparing a plaster cast by impression taking; and
a heating and pressure molding step of performing heat and pressure molding while covering the plaster cast with the rub stimulation sheet and a sheet of the thermoplastic resin in such a manner that the rub stimulation sheet is in contact with the plaster cast.

15. The manufacturing method for the multilayer mouthpiece as set forth in claim 14, wherein:
the heating and pressure molding step includes steps of:
heating a fact, to be heated, of the sheet of the thermoplastic resin to a softening temperature with a heater;
subsequently covering the rub stimulation sheet with the sheet of the thermoplastic resin in such a manner that the face of the sheet of the thermoplastic resin is in contact with the rub stimulation sheet which is placed to cover the plaster cast; and
molding the sheet of the thermoplastic resin and the rub stimulation sheet by pressing.

16. The manufacturing method for the multilayer mouthpiece as set forth in claim 14, wherein;
the heating and pressure molding step includes steps of:
heating a face, to be heated, of the sheet of the thermoplastic resin to a softening temperature with a heater;
placing the rub stimulation sheet on the face of the thermoplastic resin and pressing the rub stimulation sheet and the sheet of the thermoplastic resin to prepare a multilayer sheet; and
subsequently covering the plaster cast with the multilayer sheet in such a manner that the sheet of the thermoplastic resin of the multilayer sheet is in contact with the plaster cast; and
molding the multilayer sheet by heating and pressing.

17. The manufacturing method for the multilayer mouthpiece as set forth in claim 14, wherein:
the step of preparing the piaster cast by impression taking includes a step of preparing the plaster cast by trimming a gum portion of a model formed by impression taking in such a manner to more expose teeth of the piaster cast.

18. The manufacturing method for the multilayer mouthpiece as set forth in claim 14, wherein:
a thermoplastic resin sheet with the protrusion is used as the sheet of the thermoplastic resin.

19. The manufacturing method for the multilayer mouthpiece as set forth in claim 14, further comprising,
a step, subsequent to the heating and pressure molding step, of:
making a through-hole in the sheet of the thermoplastic resin and the rub stimulation sheet;
subsequently placing another sheet of the thermoplastic resin on the sheet of the thermoplastic resin having the through-hole;
molding the sheets of the thermoplastic resin by heating to form the protrusion on a tooth side of the tray of the thermoplastic resin, the protrusion penetrating the rub stimulation sheet for directly rubbing the gums and/or the teeth to supply stimulation to thereto.

20. A manufacturing device for the multilayer mouthpiece as set forth in claim 1, comprising:
a heater for heating a face, to be heated, of the sheet of the thermoplastic resin to a softening temperature;
a holding arm configured to hold the sheet of the thermoplastic resin and to reverse the face of the sheet, of the thermoplastic resin; and
a table for fixing a plaster cast,
wherein:
the heater, the holding arm, and the table are arranged in this order from the face of the sheet of the thermoplastic resin along a vertical direction to the face of the sheet of the thermoplastic resin; and
the holding arm and the table are configured to approach each other.

21. A manufacturing device for the multilayer mouthpiece as set forth in claim 1, comprising:
a heater for heating a face, to be heated, of the sheet of the thermoplastic resin to a softening temperature;
a holding arm is configured to move on a virtual plane parallel to the face with holding the sheet of the thermoplastic resin; and
a table for fixing a plaster cast,
wherein:
the holding arm is further configured to move between a position in the virtual plane facing the heater and a position in the virtual plane facing the table; and
the holding arm and the table are configured to approach each other while the holding arm is in the position in the virtual plane facing the table.

22. A three-dimensional rub stimulation sheet for manufacture of the multilayer mouthpiece as set forth in claim 1, comprising the rub stimulation sheet,
wherein
the rub stimulation sheet is preliminarily shaped.

23. A laminated sheet for manufacture of the multilayer mouthpiece as set forth in claim 1, wherein:
the laminated sheet includes the sheet of the thermoplastic resin and the rub stimulation sheet, which are stacked.

24. A three-dimensional laminated sheet comprising the laminated sheet as set forth in claim 23, wherein
the laminated sheet is preliminarily shaped.
